(19) United States
(12) Patent Application Publication
(10) Pub. No.: US 2002/0018259 A1
(43) Pub. Date: Feb. 14, 2002

(54) Synchronization pulse for the enhancement of the OTDM

(76) Inventor: John N. Hait, San Diego, CA (US)

Correspondence Address: PATE PIERCE & BAIRD, BANK ONE TOWER, SUITE 900, 50 WEST BROADWAY, SALT LAKE CITY, UT, 84101, US

(21) Appl. No.: 09/951,168

(22) Filed: Sep. 13, 2001

Related U.S. Application Data
(63) Continuation-in-part of application No. 09/075,046, filed on May 8, 1998, now Pat. No. 6,256,124.

(51) Int. Cl. H04J 4/00; H04J 14/00; H04J 14/08

(52) U.S. Cl. 359/123; 359/135

(57) ABSTRACT

Separation of synchronization pulses from data pulses in a combination time and wave-length division multiplexing system. Delayed and phase-shifted copies of the serial multiplexed signal are recombined through an interferometer, producing synchronization pulses which constructively intensify, while the data pulses destructively attenuate to fall below a threshold value. By this method, a phase angle of the synchronization pulses may be chosen to be different than that of the data pulses. Synchronization pulses may have a different polarization than the data pulses, enabling separation of the synchronization pulses through the use of polarized filters. The signal comprising the separated synchronization pulses may subsequently be used within a demultiplexer to facilitate extraction of the data pulses from the serial multiplexed signal into a parallel output.

### RELATED APPLICATIONS

This application is a continuation-in-part of a co-pending patent application, Ser. No. 09/075,046, filed on May 8, 1998 and directed to a Combination Photonic Time and Wavelength Division Multiplexer.

### BACKGROUND

1. The Field of the Invention

This invention relates to frequency and time division demultiplexing of photonic signals, serial-to-parallel conversion of photonic signals, preparing high-speed photonic signals for processing by lower-speed electronics, and the reception of data digits having more than two stable modulation states and which use a variety of modulation methods.

2. The Background Art

Elementary photonic time division demultiplexers are taught in U.S. Pat. No. 6,623,366 to Hait. What Hait does not teach is the apparatus and method of implementing a photonic time-division demultiplexer that uses incoming synchronization pulses to time serial-to-parallel conversion.

Hait also does not teach the use of delay mechanisms, including waveguides and optical fibers, to perform timing functions throughout the photonic demultiplexing circuits based on the incoming synchronization signals.

Also lacking is the delaying of input data by one data digit time in parallel lines to facilitate the simultaneous reading of input data to output parallel data simultaneously. Applicant finds no combination of frequency (wavelength) and time-division demultiplexing, nor pulse stretching and the use of stretched pulses to interface high-speed photonics with lower-speed electronics. Applicant finds not each one in the prior art of the use of stretched synchronization pulses for separating synchronization pulses and sets of data pulses.

Also not taught in prior art found by Applicant is the use of data comprising more than two modulation states and the use of data comprising combinations of modulation types. Thus, Applicant asserts that the prior art fails to teach how multi-state, multi-modulation-type transmissions may increase the effective bandwidth of digital transmissions.

What is needed is apparatus and methods that provide the foregoing features.

### BRIEF SUMMARY AND OBJECTS OF THE INVENTION

One object of the apparatus and method in accordance with the invention is to provide a versatile time-division demultiplexer that is capable of using photonics at the highest speed technologically feasible.

Another object of the apparatus and method in accordance with the invention is to provide a photonic-to-electronic time-division demultiplexer that may provide parallel electronic output at the highest speed that is technologically feasible for electronic components.

Another object of the apparatus and method in accordance with the invention is to provide a demultiplexer that may be tailored to match a wide variety of photonic transmission apparatus and methods and a wide variety of photonic and electronic output interfacing.

An advantage of the apparatus and method in accordance with the invention is that an apparatus and method in accordance therewith will work with a wide variety of photonic modulation methods, including amplitude, phase, polarization, and spatial modulation for the data pulses as well as the synchronization pulses. Just as compatible synchronization separation, delay mechanisms and gates may be selected for use with amplitude modulation, components may be selected to facilitate operation based on changes in carrier phase, polarization, or spatial positioning of photonic energy.

Spatial modulation provides the ability to carry a considerable amount of information in parallel, including whole images. Delay mechanisms used with spatial modulation need only be able to maintain spatial relationships, and gates need only be able to turn the entire spatially modulated signal on during the data pulse read time to yield time-division multiplexed information in a corresponding multiplexer capable of producing a series of light-speed images. This occurs much as a moving picture sends a series of light-speed images toward a movie screen or demultiplexes using the features of the apparatus and method in accordance with the invention for routing individual images or groups thereof.

Another advantage of the apparatus and method in accordance with the invention is that a method and apparatus in accordance therewith may provide multi-state outputs from multi-state inputs, thereby increasing the effective bandwidth of the apparatus and method in accordance with the invention by increasing the amount of information that is contained within a single data pulse time. Modulation-type, level-sensing, and switching components such as those disclosed in U.S. Pat. Nos. 5,093,802, 5,623,366 and 5,466,925, incorporated herein by reference, may be used with the apparatus and method in accordance with the invention to convert multi-state reception from nonbinary to binary information and may be inserted between the “n” parallel photonic outputs and the pulse stretchers. Alternatively, the conversion from nonbinary to binary may be done electronically.

Combinations of the above modulation methods may be used together to provide multi-state operation compatible with a variety of external photonic and/or electronic circuitry.

Another advantage of the apparatus and method in accordance with the invention is that it may be constructed using components compatible with frequency (wavelength) division multiplexing such as the frequency-multiplexed logic of U.S. Pat. No. 5,617,249. As a result, the apparatus and method in accordance with the invention may be used with a variety of multi-state, multi-modulation-type, multi-frequency time-division multiplexed signals.

The foregoing objects and benefits of the apparatus and method in accordance with the invention will become clearer through an examination of the drawings, description of the drawings, description of the preferred embodiment, and claims that follow.

The apparatus and method in accordance with the present invention provides an apparatus and method of frequency (wavelength) and time-division demultiplexing, remultiplexing, and routing in which serial photonic information is converted to parallel photonic or parallel electronic information. In certain embodiments, the incoming serial signal to the demultiplexer may comprise photonic pulses that start with a synchronization pulse followed by a set of “n” data pulses, the integer “n” being the number of data pulses that make up a data set. The synchronization pulses may be used to signal when the data pulses begin, end, or both.

Synchronization pulses may be separated from the data pulses and delayed using a synchronization delay mechanism. If different carrier frequencies are used, synchronization pulses may be separated for each frequency channel.

The serial input is also distributed to “n” delay mechanisms to produce “n” copies of the input data set, each successive copy being delayed by a different amount of time. Each of these delay mechanisms may differ in delay time by the duration of one data pulse so that each data pulse in a data set is timed to match the delayed synchronization pulse.

The “n” delayed data pulse sets may be input into “n” photonic gates. Thus, all “n” photonic gates may be opened simultaneously by the delayed synchronization pulse(s). Since each gate has, at the time of the delayed synchronization pulse(s), a different data pulse at its input, opening these gates simultaneously during that delayed synchronization pulse may output simultaneous parallel individual data pulses that may be transmitted to other photonic devices.

One advantage of outputting parallel data rather than sequential data is that external parallel circuitry may be more easily interfaced with apparatus in accordance with the invention. By delaying the data pulses in parallel lines and reading them simultaneously after the last data pulse has arrived, the entire parallel data set may be output simultaneously. Accordingly, such output may be connected to other photonic or electronic circuitry.

Photonic pulses may be much shorter than the response time of the typical electronic or electro-optical device. To interface slower electronics with high-speed data pulses, photonic pulse stretchers may be provided to increase the pulse width of the parallel photonic outputs enough to make the data signals compatible with the electronic devices to be used with the apparatus and method in accordance with the invention.

Thus, one advantage of the apparatus and method in accordance with the invention is that slower electronics may now be interfaced with higher-speed photonics. By providing simultaneous parallel data, the same time span needed for serial data transmission of a fill data frame (e.g. overhead, synchronization pulse, and full data set) may be made available for stretching photonic signals during the transmission of the following frame. As a result, the stretched pulses may be read by slower electro-optical devices without interrupting the sequence of frames.

To allow for this needed interface time, the number of data digits in a single data set may be increased until the full data set transmission time is at least as long as the needed electronic response time. As a result, both the photonics and the electronics may be made to operate at peak technological performance.

Because photonics and fiber optic systems are able to operate so much faster than electronics, a typical system may have many hundreds or even thousands of data pulses per frame, or even per bit, in order to provide enough time for electronic circuits to respond. As a result, one particular embodiment of the apparatus and method in accordance with the invention may provide many (e.g. dozens, hundreds, thousands) parallel output lines. Such large electronic bus widths may be used with present electronics, even if a large number of electronic computers are required to fully use the capability. Incoming data may be organized during transmission so that each receiving computer gets its proper information. The apparatus and method in accordance with the invention may also be able to accept data frames asynchronously on separate carrier frequencies.

Another advantage of the apparatus and method in accordance with the invention is that it may be able to use the large variety of photonic gates available in the art and may not be restricted to a specific photonic gate except by engineering choice. Such photonic gates include the use of negative logic and multilevel negative synchronization and data pulses wherein the logic output is substantially off while the data positions are being read by the delayed synchronization pulse.

At least two of the “n” data slots are required to define the apparatus and method in accordance with the invention. Therefore, the basic method of the present photonic serial-to-parallel converter using delayed-pulse timing may include the elements and methods of the following paragraphs.

In certain embodiments, an apparatus in accordance with the invention may receive a serial input signal comprising pulses of photonic energy having synchronization pulses and sets of data pulses, the data pulses including at least first and second sets of data pulses. A synchronization pulse separator may be configured to receive the serial input signal and separate the synchronization pulses from the serial input signal to provide separated synchronization pulses. First and second photonic gates may be configured to receive the separated synchronization pulses, thereby opening the gates.

Meanwhile, the serial input containing the first and second sets of data pulses may be received in parallel by first and second delay mechanisms. These may be configured to delay the serial input by first and second delays and transmit them to the first and second photonic gates, respectively. The first and second delays are timed such that the first and second sets of data pulses arrive simultaneously at the first and second photonic gates coincidentally with the synchronization pulses, thereby providing first and second parallel outputs from the first and second photonic gates. Thus, the first and second sets of data pulses contained in the serial input signal may be converted to parallel data.

Since electronic components are typically much slower than photonic components, to interface the photonic data outputs with electronic components, first and second pulse stretchers may be provided to stretch the first and second parallel outputs sufficiently so as to fall within the response time of first and second optoelectronic devices. Accordingly, the first and second optoelectronic devices provide first and second parallel electronic outputs.

To interface photonic synchronization with electronic components, a third pulse stretcher may be used to stretch the synchronization pulses sufficiently to fall within the response time of a third optoelectronic device, used to provide an electronic synchronization pulse. Such an electronic synchronization pulse may be used by the apparatus and method in accordance with the invention to provide an indicator when the parallel electronic outputs are set up and ready to be read.

Separating synchronization pulses from the input pulse stream may be necessary to prevent data information from adversely affecting the demultiplexing process with certain synchronization pulse transmission methods. Photonic separation may be quite advantageous because available photonic switching components are much faster than their electronic equivalents.

An apparatus and method in accordance with the invention may use pulse timing and delay mechanisms to provide synchronization pulses that have been separated from the input data stream. In one embodiment, the serial input may be directed into a photonic inhibiting gate that passes information through until an inhibiting signal prevents passage.

Because each synchronization pulse, which is comparable to the start pulse used in asynchronous electronic communications, arrives before the data, that synchronization pulse may be reproduced and delayed to coincide with each of the following data pulses. The synchronization pulse may also be stretched into an inhibiting pulse to cover the time used by each data set and used to inhibit passage of data through the inhibiting gate.

Since the stretched inhibiting pulse may be timed to shut off after the nth data pulse, the inhibiting gate may be reopened in preparation for the following synchronization pulse of the following asynchronous frame. The result is photonically separated synchronization pulses.

In one embodiment, the method for separating the synchronization pulses from the data may include an inhibiting gate and a synchronization pulse stretcher, wherein the serial input is received by the inhibiting gate. A pulse stretcher may be connected to the inhibiting gate and configured to stretch the synchronization pulses to provide inhibiting pulses substantially as long as the sets of data pulses contained within the serial input. These inhibiting pulses may also be timed to coincide with the sets of data pulses. The inhibiting pulses may be routed back into the inhibiting gate to close the inhibiting gate, thereby allowing only the synchronization pulses to pass through the inhibiting gate and preventing the sets of data pulses to pass therefrom. Thus, in this embodiment a method is provided to separate the synchronization pulses from a serial input.

In certain embodiments, a method for stretching photonic pulses may include receiving a photonic pulse having a length. The photonic pulse may be directed in parallel to a plurality of delay mechanisms, each having a delay differing substantially from the length of the photonic pulse. The number of delay mechanisms used within the pulse stretcher may be determined by the pulse length needed. Subsequently, the outputs from each of the delay mechanisms may be combined into a single stretched pulse having a length greater than the original pulse length.

The effective bandwidth of a binary transmission system may be increased by using analog or multi-state digital transmissions such as ternary, quaternary, hexadecimal, and so on. An apparatus and method in accordance with the invention has the advantage of being able to time-division demultiplex multi-state signals by providing multi-state serial inputs and selecting components compatible with multi-state signals. Such input may be either photonic or electronic by choosing the appropriate components.

### BRIEF DESCRIPTION OF THE DRAWINGS

The foregoing and other objects and features of an apparatus and method in accordance with the invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a block diagram of a photonic serial-to-parallel converter that constitutes the time-division demultiplexer of an apparatus and method in accordance with the invention;

FIG. 2 is a pulse timing diagram of the demultiplexer in accordance with the invention;

FIG. 3 is a pulse diagram illustrating several examples of multistate inputs/outputs;

FIG. 4 is a block diagram of one embodiment of a pulse stretcher that uses multiple delay mechanisms in a parallel configuration;

FIG. 5 is a schematic block diagram of one embodiment of a demultiplexer, multiplexer, and remultiplexer which allows routing of information through unbundling and rebundling of information;

FIG. 6 is a schematic block diagram of one embodiment of a multiplexer wherein the synchronization pulses are encoded before being combined into the serial photonic output;

FIG. 7 is a schematic block diagram of one embodiment of a demultiplexer of an apparatus and method in accordance with the invention employing a synchronization pulse separator; and

FIG. 8 is a timing diagram of the various delayed copies of the serial photonic signals used within the synchronization pulse separator.

### DETAILED DESCRIPTION OF THE PREFERRED EMBODIMENTS

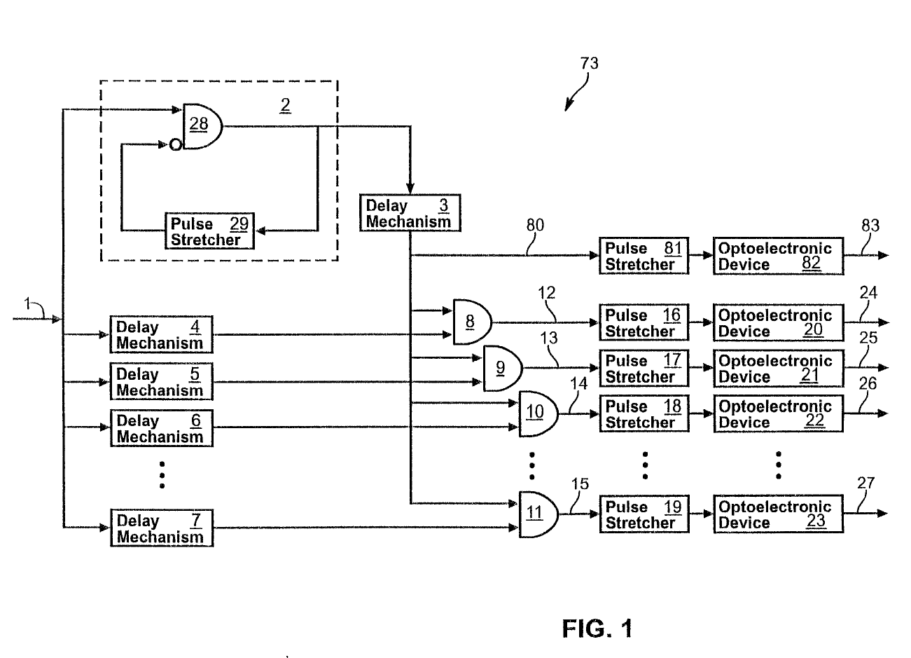

It will be readily understood that the components of an apparatus and method in accordance with the invention, as generally described and illustrated in the Figures herein, may be arranged and designed in a wide variety of different configurations. Thus, the following more detailed description of the embodiments of an apparatus and method in accordance with the invention, as represented in FIGS. 1 through 8, is not intended to limit the scope of the invention. The scope of the invention is as broad as claimed herein. The illustrations are merely representative of certain, presently preferred embodiments in accordance with the invention. Those presently preferred embodiments will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

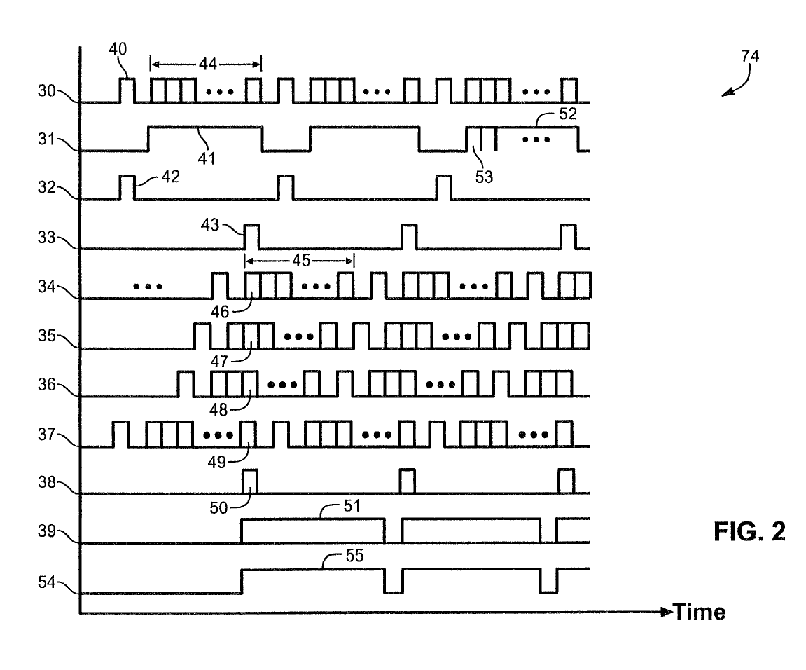

Because FIG. 1 is a block diagram of the time/frequency division demultiplexer, serial-to-parallel converter of an apparatus and method in accordance with the invention and FIG. 2 is a pulse timing diagram of the various signals within the apparatus of FIG. 1, this embodiment is best understood by considering both figures together.

Referring to FIGS. 1 and 2, a serial photonic signal comprising a series of pulses as illustrated on time line 30 may be received by the invention at input 1. The serial photonic signal may comprise a frame of pulses that include a synchronization pulse such as pulse 40 and a set of “n” data pulses such as data frame 44 followed by like frames of synchronization and data pulses.

The integer “n”, as used hereinafter, refers to the number of data pulses in the data set of a single frame, which is positioned in time between the synchronization pulses. The first three data pulses plus the nth data pulse are illustrated in FIG. 2, such as is illustrated in data frame 44. The three dots between pulses shown on time lines 30, 31 and 34-37 of FIG. 2 indicate similar data pulses, and the . . . between components in FIG. 1 indicate similar components used to process each of the intervening data pulses. At least first and second data pulses will typically be needed to have serial data converted into parallel data.

Referring to FIG. 2, pulses represented by a top line only, such as 40 and 42, are required pulses. Pulses having both a top and bottom line, such as data frame 44 and data signal 50, are modulated with data and may be able to be in a number of modulation states depending on the data transmission method. In the case of multi-level modulation states, these pulses represent time positions and relationships for accomplishing specific tasks rather than binary conditions.

An apparatus and method in accordance with the invention may use a number of delay mechanisms for coordinating the timing of the various signals. Photonic delay mechanisms may be free-space distances through which signals are made to travel, fiber optics, waveguides, or complex circuits that may include amplifiers, flip flops, one-shot multivibrators, and the like to produce the delays.

To accomplish serial-to-parallel conversion, the synchronization pulses may be first separated from input 1 using a synchronization pulse separator 2 that produces, for example, a sequence of synchronization pulses like synchronization pulse 42 as shown on time line 32. If the synchronization pulses are modulated or positioned in an otherwise recoverable form, they need not precede the data pulse time slots, as shown on time line 30. The exact requirements for synchronization pulse separation may depend upon the modulation and timing characteristics of the synchronization pulses provided at input 1. Certain modulation configurations may require no modification of the input signal before it is routed to the photonic gates 8-11.

In this case, a synchronization pulse separator 2 may merely be served by the separation of an amplitude portion of the input signal from input 1. As a result, an apparatus and method in accordance with the invention may provide considerable latitude for engineering choice and for customizing the apparatus and method to match a large variety of transmission protocols.

Separated synchronization pulses shown on a time line 32 may then be delayed using a delay mechanism 3 to produce the delayed synchronization pulses shown on time line 33. For example, a delayed synchronization pulse 43 shows the delay that has occurred when compared to synchronization pulse 42. These delayed synchronization pulses may be used to read each of the “n” data time slots within a set of “n” data pulses such as data frame 44 shown on time line 30 to produce a parallel photonic data output as shown on time line 38. Since all of the “n” data pulses in the parallel photonic data output may be made to occur at the same time, the pulse waveforms for each output will appear the same as those shown on time line 38.

The pulses, such as a synchronization pulse 40 and those in the data frame 44 of the input 1 as shown on time line 30 may also be routed into “n” delay mechanisms 4-7, the n^{th} delay mechanism. Time lines 34 through the n^{th} time line, 37, show what happens to pulses that are routed through “n” delay mechanisms 4-7, the n^{th} delay mechanism. Each of these “n” delay mechanisms may have a time delay that differs by the time of a single data pulse such as the data pulse 46. As a result, delayed data signals as shown by the time lines 34 through the n^{th} time line, 37, may be produced such that each delayed data signal has a different data pulse timed to match a delayed synchronization pulse. For example, the data pulse 46 in a delayed data pulse set 45 is timed to match a delayed synchronization pulse 43.

Likewise, the second delayed data signal as shown on time line 35 has its second data pulse 47 timed to match the delayed synchronization pulse 43. The third delayed data signal shown on time line 36 has its data pulse 48 timed to match the delayed synchronization pulse 43. The n^{th} delayed data signal shown on the time line 37 has its n^{th} data pulse 49 timed to match the delayed synchronization pulse 43. All “n” delayed data signals are routed into photonic gates 8-11, the n^{th} photonic gate. These photonic gates remain closed until they are opened by the delayed synchronization pulses shown on time line 33.

In the example illustrated by the time lines of FIG. 2, a delayed synchronization pulse 43 opens the gates 8-11 to allow the data pulses 46-49 to pass into the parallel photonic outputs 12-15, the n^{th} photonic output, all of which are shown as data signal 50 as explained previously. When the photonic gates are closed, the other pulses within each of the “n” delayed data signals are blocked because the delayed synchronization pulse signal is off.

These parallel photonic data outputs as shown on time line 38 may be routed directly into other photonic devices as needed, including direction into one or more multiplexers. These multiplexers can be used with an apparatus and method in accordance with the invention for unbundling and rebundling data packets or frames for routing to different locations or for changing the order or protocol of information contained therein. Photonic pulses, however, may be much shorter than the response time of electronic or other devices. To interface the photonic output to an electronic circuit, pulse stretchers 16-19, the n^{th} pulse stretcher, one construction of which is shown in FIG. 4, may be connected to photonic outputs 12-15.

The outputs of these pulse stretchers as shown on time line 39, such as the stretched pulse 51, may then be received by optoelectronic devices 20-23, such as photo diodes. In turn, these optoelectronic devices 20-23 may provide parallel electronic outputs 24-27. Electronic outputs may occur during the same pulse times shown on time line 39, but slower electronic responses may cause the waveforms to deviate from the square-wave form illustrated. This may be used to advantage by directing the short pulses from the signals 12-15 into optoelectronic devices directly, then correcting the distorted outputs electronically using electronic wave-shapers, for example. This may be accomplished while performing the pulse stretching electronically because an apparatus and method in accordance with the invention produces comparatively long time delays between the demultiplexed pulses that leave time for pulse stretching.

A variety of photonic gates 8-11, may be used, including photonic transistors, frequency multiplexed logic, nonlinear optical elements, Self Exciting Electro-optical Devices (SEEDS), and other high-speed optical gates. While FIG. 1 uses the conventional pictorial notation that indicates the use of a Boolean AND, any of the switching equivalents will work, including the use of negative logic wherein the positive Boolean OR provides the AND gate function.

An apparatus and method in accordance with the invention can be used with both time-division-multiplexed and wave-division-multiplexed signals. In fact, using suitable components, an apparatus and method in accordance with the invention can also be used with legacy systems of time-division multiplexing and wave-division multiplexing. In one embodiment, the photonic gates 8-11 of FIG. 1, can be photonic transistors of frequency-multiplexed logic components. Such components have been shown to have extremely fine photonic resolution which, when incorporated into an apparatus and method in accordance with the invention, allow the invention to have a much finer resolution for determining one frequency channel or wave-division multiplexed channel from its neighbor. Being a much finer filter that is often used in cases of prisms, diffraction gratings, and the like, an apparatus and method in accordance with the invention can demultiplex far more information from the serial data input than conventional methods.

A synchronization strobe is usually needed so that outside devices will know when parallel data is set up and ready to be read. For example, delayed synchronization pulses, such as the synchronization pulse 43 as shown on the time line 33, may be routed along a line 80 of FIG. 1 to provide a photonic synchronization output to indicate when photonic outputs 12-15 are set up and ready to be read.

If an electronic or other comparatively slow interface is needed, the delayed synchronization pulses on the line 80 may be directed to a pulse stretcher 81, one construction of which is shown in FIG. 4, to provide stretched synchronization pulse 55 as shown on time line 54. These stretched synchronization pulses 55 are then routed into optoelectronic device 82 to provide an electronic strobe 55 or electronic synchronization 55 at output 83, also shown on time line 54.

Depending on the components and interfacing configuration chosen, an additional delay may need to be included en route so that parallel data output has time for complete setup before the strobe indicates that it is ready. This delay may be built in at any point from line 80 through output 83. Alternatively external circuitry may provide the needed strobe timing. The separated synchronization signal received from the synchronization pulse separator 2 may also be used, rather than using the output of delay mechanism 3, by including extra delay mechanisms as engineering requires.

One important advantage of an apparatus and method in accordance with the invention is that the number of data pulses in a data set, such as data frame 44, may be engineered to allow enough time to meet the response characteristics of the electronic components interfaced to an apparatus in accordance with the invention. The available time for electronic response may be lengthened by including more data pulses in a data frame.

For example, common optoelectronic devices are capable of operating at a speed of 2 Ghz with a pulse time of 0.5 ns (nanoseconds), whereas photonic pulses may be produced having a much shorter pulse duration of, for example, 0.0005 ns. As a result, if n=1,000, then each of 1,000 parallel outputs may operate at the maximum speed for these available electronic components, while using the speed advantage of photonics to increase the overall bandwidth.

A variety of mechanisms may be used within the synchronization pulse separator 2 for separating the synchronization pulses, such as synchronization pulse 40, shown on time line 30 from input 1. One embodiment may include the use of a pulse stretcher 29 that produces an output started by each synchronization pulse, such as synchronization pulse 40, to produce inhibiting pulses such as the inhibiting pulse 41. As shown on the time line 31, the pulses 41 are at least as long as data frame 44, shown on time line 30.

Some transmission systems may provide shorter synchronization pulses so that the data read will take place completely within the delayed data pulses. In that case, the number of delay mechanisms 68-71 used in the synchronization pulse stretcher 76 may have to be increased. For transmission systems that do not use shorter synchronization pulses, a synchronization pulse shortener may be needed prior to photonic gates 8-11. Photonic pulses may be shortened using devices as described by U.S. Pat. No. 5,623,366 to Hait, incorporated herein by reference.

Following the synchronization pulse 40, an inhibiting pulse 41 may close the inhibiting gate 28, which prevents the following data frame 44 from passing through the inhibiting gate 28. The inhibiting pulse 41 may be engineered to shut off following the last data pulse in the data frame 44 to open the inhibiting gate 28 in time to allow the next synchronization pulse to pass. As a result, only synchronization pulses, such as the synchronization pulse 42, shown on time line 32, pass through gate 28 and, therefore, out of the separator 2.

Synchronization pulse separation may also be accomplished using synchronization pulses that have modulation characteristics different from those of the data pulses. Some of these may include different amplitude, phase, polarization, frequency, and wave form. The synchronization pulse may also be derived from data transmission protocols, by using photonic components that are compatible with the high-speed switching characteristics of photonic transistors, etc.

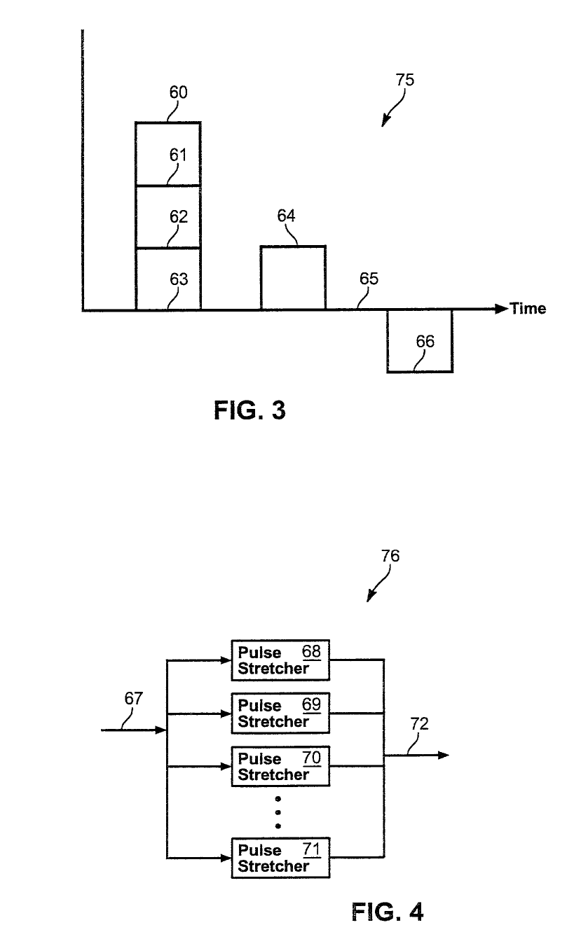

Referring to FIG. 3, multi-state data pulses may also be used to increase effective bandwidth of the multiplexing system. FIG. 3 illustrates two examples of the many possible combinations of multi-state semaphore digits (for synchronization or data) that may be demultiplexed from multi-state serial inputs to multi-state parallel outputs.

For example, quaternary transmission may use four pulse levels. Rather than being simply on or off as in the case of binary transmission, one of the transmission levels 60, 61, 62, 63 may be transmitted at a time to represent two bits of binary information. An apparatus and method in accordance with the invention may pass these levels 60-63 through into its photonic outputs 12-15 and pulse stretchers 16-19 to its electronic outputs 24-27.

Another example of multi-state transmission is illustrated by transmission levels 64-66. In this case, both amplitude and phase modulation may be combined to produce a ternary system. A level 64 may have a carrier wave phase that is 180 degrees out of phase with the level 66. The level 65 may be amplitude-modulated so that it is substantially off. This type of transmission may be particularly compatible with interference-based photonics since it may be produced by certain photonic transistors.

Certain embodiments of devices in accordance with the present invention may be compatible with a variety of modulation methods, including amplitude, phase, spatial, and polarization modulation by the proper engineering choice of compatible photonic components. As shown in FIG. 3, these various modulation methods, including Walsh functions, may be mixed and matched to produce complex informational systems that may be converted from higher-speed serial to lower-speed parallel signals in accordance with the invention.

Amplifiers, both photonic and electronic, may be inserted as needed in the various signal lines of an apparatus and method in accordance with the invention. Pulse stretchers using photonic components such as flip flops and one-shot multivibrators as disclosed in U.S. Pat. Nos. 5,093,802 and 5,623,366 may also be used.

Referring to FIG. 4, a simple photonic pulse stretcher 76 of a type that may be used as any of the pulse stretchers 16-19, 29, or 81, is illustrated in FIG. 4. The delay mechanisms 68-71, (e.g. the n^{th} delay mechanism), may transmit pulses such as the pulse 42, shown on the time line 32, to a pulse stretcher input 67. Each of the successive delay mechanisms 68-71 may have a delay that is approximately the width of one data pulse (such as the pulse 50 on the time line 38) longer than the preceding one. When the delayed outputs at pulse stretcher output 72 are combined, a single stretched pulse, such as the data 51, shown on time line 39, may be produced.

An apparatus and method in accordance with the invention may also be compatible with certain time-division multiplexing transmitters that use synchronization pulses having a pulse width different from that of the data pulses. In this case, the number of delay mechanisms in FIG. 4 may simply be adjusted to provide the needed stretched pulse width. Additionally, amplifiers may be inserted either inside or outside of the delay mechanism as needed to provide proper signal strengths.

An apparatus and method in accordance with the invention may use negative logic by providing separated synchronization pulses that are off at the data testing coincidence time (as previously illustrated by the delayed synchronization pulse 43 and the data signal 50) by inverting the signal on the time line 33. An advantage of negative logic may be that the negative synchronization pulse does not always have to be phase-matched to the incoming signal at input 1 before coincidence at the photonic gates 8-11.

Negative logic as used in an apparatus and method in accordance with the invention may be used with noisy and otherwise difficult-to-detect input signals. A negative logic synchronization pulse may be produced by inverting the separated synchronization pulses 43, or by using a negative input synchronization pulse with or without the positive synchronization pulse 40. The use of multi-level input signals may also simplify engineering choices.

An apparatus and method in accordance with the invention may also be used as a combination wavelength and time-division multiplexer by using frequency-multiplexed logic, such as that taught in U.S. Pat. No. 5,617,249, at photonic gates 8-11. Wavelength-division multiplexed signals for each time division may be maintained at the photonic outputs 12-15. Alternatively, the synchronization pulses may be separated by wavelength in the synchronization pulse separator 2 and routed to separate photonic gates, thereby permitting the entire spectrum of wavelength-division and time-division multiplexed signals to be completely demultiplexed into separate parallel outputs.

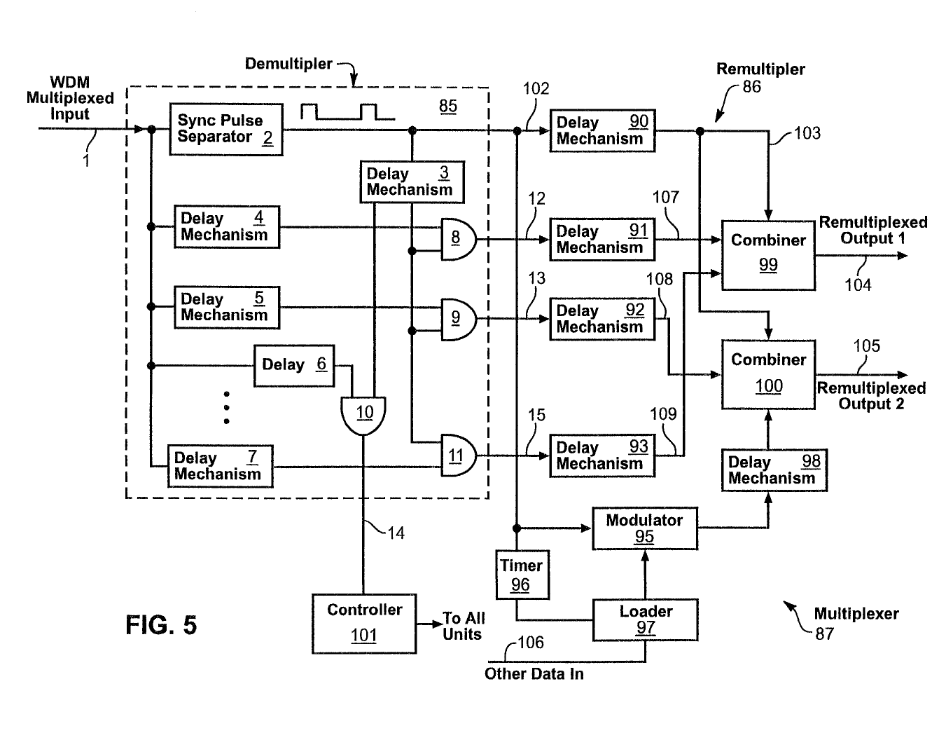

Referring to FIG. 5, a multiplexed input 1, which is directed into a demultiplexer 85 as described in a portion of FIG. 1, provides the output from the demultiplexer as photonic signals 12, 13, and 15. By providing suitable delay mechanisms 91, 92, 93 between these signals 12, 13, 15, the information therein can be remultiplexed in a remultiplexer 86 portion of the apparatus. By directing the delayed demultiplexed signals 107, 108, 109 into combiners 99, 100 along with a synchronization signal 102, delayed to produce a delayed synchronization signal 103, also directed into the combiners 99, 100, information may be unbundled and rebundled to provide a plurality of remultiplexed outputs 104, 105.

Additionally other data 106 may be directed into a loader 97, which loads the data 106 into a modulator 95 with the help of a timer 96, to produce a multiplexer 87 similar to that described in the co-pending application Ser. No. 09/075,046 from which this continuation-in-part depends. By directing the output of the multiplexer 87 through a delay mechanism 98 and into the combiner 100 this other data may be included within the information remultiplexed and sent out of output 105. As a result, the illustrated embodiments can be used as an information router, that can unbundle and rebundle information, in order to make it compatible with a variety of transmission protocols. At the same time, certain embodiments may allow the mixing and matching of protocols, as well as photonic components with electronic components. The pulse stretching provisions of an apparatus and method in accordance with the invention, as described in FIGS. 1 and 4, can be used, if needed, in order to make all the components work in harmony.

The embodiment of FIG. 5 may also include a controller 101, connected to multiple instances of apparatus in accordance with the invention to dynamically control the organization, reorganization, and demultiplexing of information.

A delay mechanism 6, may take the serial photonic input signal 1, delay it, and direct it into a photonic gate 10, wherein the output is the demultiplexed signal 14 which is directed into the controller 101. As a result, information from the serial photonic input 1 may be used to operate the controller 101. The controller 101 may in turn determine the operation of the remultiplexing of the information, so that an apparatus and method in accordance with the invention may be used as a wideband router.

The router may be configured to examine information such as addresses, that are input on any one of the frequencies, the pulse bit positions, or the variety of methods for providing data either as binary or as multilevel semaphores. These inputs may control the redistribution of individual sets of photonic data pulses. The router may also be configured to keep track of photonic data packets or photonic data frames, thus rearranging the information in any desired order or configuration.

Various apparatus in accordance with the present invention may operate as a wave-division demultiplexer, a wave-division remultiplexer, a time-division demultiplexer, and a time-division remultiplexer, having use of frequency multiplex logic and photonic transistors. A single device can have a much larger throughput than by prior methods. This is because of the fine resolution and agility of manipulating the information.

In accordance with an apparatus and method in accordance with the invention, it becomes necessary to provide a method to separate the synchronization pulses from the data pulses of the incoming serial signal. One reason for this is that, as has been previously described for the demultiplexer of FIG. 1, the synchronization pulses may be used to extract the data pulses from the serial photonic signal through a series of AND gates. Therefore, in certain embodiments a method may be provided for encoding the synchronization pulses in the multiplexer disclosed herein. The multiplexer may then enable the pulses to be recognized by the demultiplexer to facilitate separation of the synchronization pulses from the data pulses.

By selectively choosing the phase angles of the synchronization pulses in relation to the phase angles of the data pulses, delayed copies of the serial multiplexed output may be recombined in such a way that the synchronization pulses constructively recombine to increase their intensity, while the data pulses destructively recombine to attenuate in intensity. Thus, the synchronization pulses may be effectively separated from the data pulses. A method that may be used to achieve this end will be described.

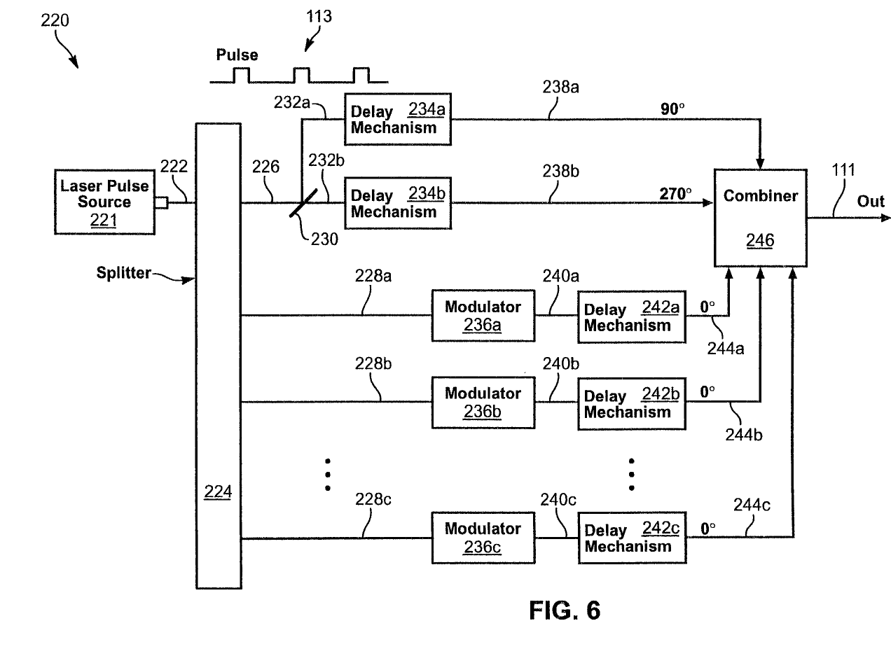

Referring to FIGS. 6-8, a multiplexer 220 may include a laser pulse source 221. A splitter 224 may be operably connected to receive a laser pulse train 113 from a laser pulse source 221 through a line 222, producing daughter signals 226, 228a, 228b, 228c. A daughter signal 226 may be subsequently split again by a splitter 230 into a pair of daughter signals 232a, 232b. A signal 232a may be passed through a first delay mechanism 234a, imposing both a time and/or phase-shift delay on the signal 232a. Likewise, a signal 232b may be passed through a second delay mechanism 234b, imposing a second time and/or phase-shift delay on the signal 232b.

For example, in one embodiment, a first delay mechanism 234a may produce a signal 238a having a phase angle of 90° and a first time delay. Similarly, another delay mechanism 234b may produce a signal 238b having a second phase angle of 270° and a second time delay.

Meanwhile, daughter signals 228a, 228b, 228c may be modulated with data by modulators 236a, 236b, 236c to produce data signals 240a, 240b, 240c. Data signals 240a, 240b, 240c may then be delayed, each by a different amount, by delay mechanisms 242a, 242b, 242c to time the signals for combining into a serial output.

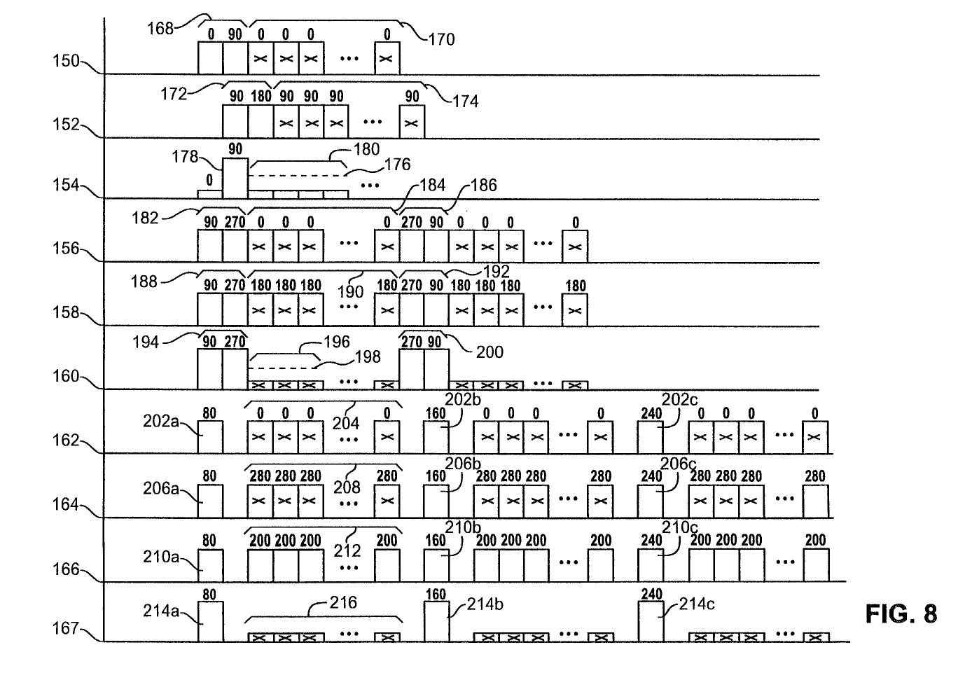

A combiner 246 may be operably connected to receive synchronization pulses from lines 238a, 238b and delayed data pulses from the lines 244a, 244b, 244c in order to combine them into a single multiplexed output 111. For example, referring to FIG. 8, the time line 156 illustrates one embodiment of a multiplexed serial output 111. Synchronization pulses 182 illustrate one embodiment wherein one pulse has a phase angle of 90° and a second has a phase angle of 270°.

The synchronization pulses may be configured to have other phase angles, the reason for which will be explained hereafter. Following the synchronization pulses are data pulses 184, which in this embodiment all have a phase angle of 0°. Likewise the data pulses need not have a phase angle of 0°, but may be configured to have other phase angles.

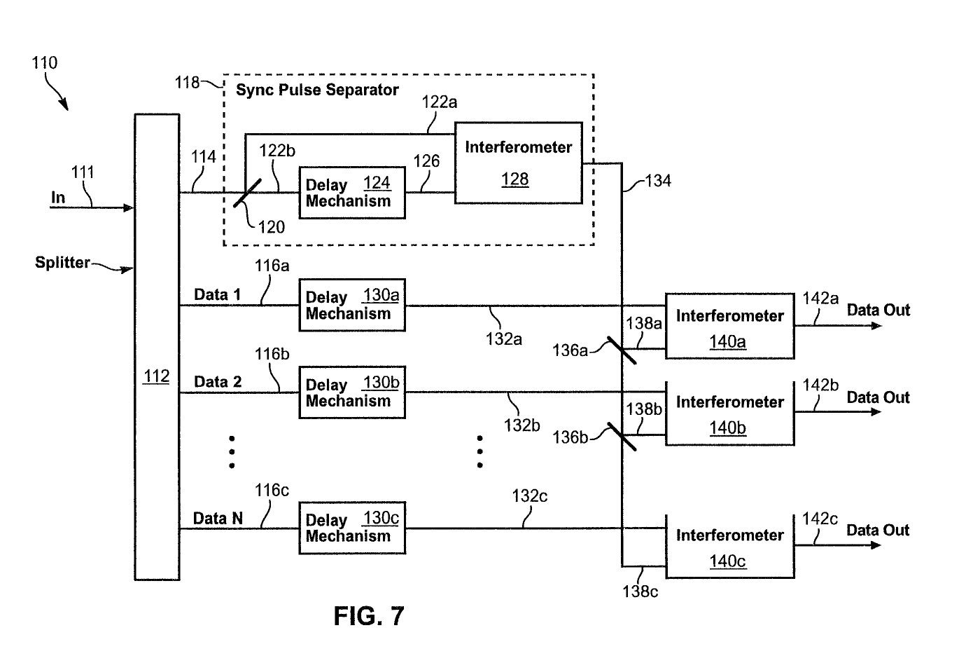

Referring to FIG. 7, while continuing to refer generally to FIG. 6-8, one embodiment of a demultiplexer 110 in accordance with the present invention may include a splitter 112. The splitter 112 may be configured to receive a serial multiplexed signal 111, such as the signal depicted on the time line 156 of FIG. 8. The splitter 112 may split a signal 111 into daughter signals 114, 116a, 116b, 116c. A daughter signal 114 may again be split into a pair of daughter signals 122a, 122b by a splitter 120. The signal 122b may be delayed by a delay mechanism 124 by a certain time and phase angle to produce a delayed signal 126. Signals 122a, 126 may then be recombined in an interferometer to produce a resultant signal 134.

For example, referring to FIG. 8, a time line 156 illustrates one embodiment of a multiplexed serial signal 111, such as might be received on a line 122a of the demultiplexer of FIG. 7. In this embodiment, a serial signal of the time line 156 is configured to have synchronization pulses that alternate in phase by 180°. For example, on the time line 156, the synchronization pulses 182 have phase angles of 90° and 270° respectively. Conversely the next synchronization pulses 186 have phase angles of 270° and 90°. The serial signal may be configured to repeat this pattern.

The time line 158 illustrates the same multiplexed serial signal 111 of the time line 156 delayed by one fill synchronization pulse cycle (the time between successive synchronization pulses) plus a phase shift of 180°, such as might be received from a delay mechanism 124 on a line 126 of FIG. 7.

The two serial signals of the time lines 156, 158 may then be received by an interferometer 128 (Referring back to FIG. 7) to produce an output 134 as illustrated on the time line 160. For example, because the synchronization pulses 182, 188 have the same phase angle, they constructively combine within the interferometer 128 to form an intensified synchronization pulse 194. Conversely, since the data pulses are now 180° out of phase (caused by the 180° phase shift), the resulting pulses 196 are attenuated due to destructive interference. The data pulses 196 may not completely disappear, but may fall below a certain threshold value 198 making them substantially removed. This may essentially remove the data pulses from the signal 134, while increasing the relative intensity of the synchronization pulses.

Referring again to FIG. 7, the daughter signals 116a, 116b, 116c of a serial multiplexed signal 111 may be received by delay mechanisms 130a, 130b, 130c, each imposing a different delay on the daughter signal received thereby. The purpose of delay mechanisms 130a, 130b, 130c may be to time the coincidence of the data pulses with separated synchronization pulses on a line 134, as described with respect to FIG. 1 and FIG. 2. Delayed signals 132a, 132b, 132c may be received by interferometers 142a, 142b, 142c which may effectively function as AND gates. Likewise, splitters 138a, 138b may split a signal 134 and route separated synchronization pulses to the same interferometers 142a, 142b, 142c through various lines 138a, 138b, 138c. Thus, only when synchronization pulses are incident on interferometers 142a, 142b, 142c are the gates 142a, 142b, 142c open and the data pulses allowed to pass, as described with respect to FIG. 1.

Referring again to FIG. 8, in another embodiment, a multiplexed signal 111, such as might be on lines 122a, 122b, may be configured to appear as illustrated by a time line 150. Synchronization pulses 168 may be configured to have 0° and 90° phase angles and data pulses may have a phase angle of 0°, for example. The time line 152 illustrates a copy of the serial signal shown on the time line 150 delayed in time by the pulse width of one synchronization pulse plus a 90° phase shift. Such a signal might be carried by a line 126 following a delay mechanism 124.

The two serial signals represented by the time lines 150, 152, when combined in an interferometer such as an interferometer 128 of FIG. 7, may produce an output similar to that shown on a time line 154. The parts of synchronization pulses 168, 172 having a 90° phase angle may constructively combine to form an intensified synchronization pulse 178. Conversely, data pulses 170, 174 may destructively combine to form attenuated pulses 180, which may fall below a selected threshold value 176.

In another possible embodiment, as is shown on a time line 162, a multiplexed signal 111 may be configured wherein successive synchronization pulses 202a, 202b, 202c increase by a selected amount, such as 80° in this example. A plurality of delay mechanisms, such as a delay mechanism 124 of FIG. 7, may be configured to produce copies of a signal of the time line 162 delayed by one synchronization cycle plus a phase shift of −80°, for example. This would produce multiple, delayed, phase-shifted copies such as those illustrated on the time lines 164, 166. When combined in an interferometer 128, synchronization pulses 202a-c, 206a-c, 210a-c may combine to produce intensified synchronization pulses 214a-c, while data pulses 204, 206, 212 may combine to form attenuated pulses 216.

One reason for combining multiple delayed copies 164, 166 of the serial output of time line 162 may be that with each additional combination, further intensifying of synchronization pulses 214a-c and further attenuation of signals 216 may be achieved. Synchronization pulses 202a-c may differ by more or less than the cited example of 80°, the goal being to separate the synchronization pulses 202a-c from the data pulses 204.

An apparatus and method in accordance with the invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. A method for separating synchronization pulses from serial photonic signals, the method comprising:
providing a serial photonic signal comprising a plurality of data pulses, each having a first phase angle, the data pulses being separated by a plurality of synchronization pulses, each having a second phase angle;
splitting the serial photonic signal into an arbitrary number of copies, each copy thereof being delayed and phase-shifted by an arbitrary amount; and
recombining the copies, in an order selected to constructively intensify the synchronization pulses and destructively attenuate the data pulses signal to a signal strength below a selected threshold value.

2. The method of claim 1, further comprising using the synchronization pulses to extract the data pulses from the serial photonic signal.

3. The method of claim 2, further comprising using the synchronization pulses to amplify the data pulses.

4. The method of claim 1, wherein each synchronization pulse is divided into a plurality of sub-pulses, each sub-pulse having a unique phase angle.

5. The method of claim 1, wherein the phase angle of successive synchronization pulses alternates by 180°.

6. The method of claim 1, wherein the synchronization pulses and data pulses have different polarization angles.

7. The method of claim 6, further comprising separating the synchronization pulses from the data pulses using a polarization filter.

8. The method of claim 1, wherein recombining the copies further comprises passing the copies into an interferometer.

9. A apparatus for separating synchronization pulses from serial photonic signals, the apparatus comprising:
a serial photonic signal comprising a plurality of data pulses, each having a first phase angle, the data pulses being separated by a plurality of synchronization pulses, each having a second phase angle;
a splitter configured to split the serial photonic signal into an arbitrary number of copies;
an arbitrary number of delay mechanisms configured to delay and phase-shift the copies, each by an arbitrary amount; and
a combiner configured to recombine the copies, such that the synchronization pulses are constructively intensified and the data pulses are destructively attenuated, such that the signal strength of the attenuated data pulses falls below a certain threshold value.

10. The apparatus of claim 9, for then comprising a gate configuration to the synchronization pulses to extract the data pulses from the serial photonic signal.

11. The apparatus of claim 10, further comprising an amplifier configured to the synchronization pulse to amplify the data pulses.

12. The apparatus of claim 9, wherein each synchronization pulse is divided into a plurality of sub-pulses, each sub-pulse having a different phase angle.

13. The apparatus of claim 9, wherein the phase angle of successive synchronization pulses alternates by 180°.

14. The apparatus of claim 9, wherein the synchronization pulses and data pulses have distinct polarization angles with respect to one another.

15. The apparatus of claim 14, further comprising a polarization filter configured to separate the synchronization pulses from the data pulses according to polarization.

16. The apparatus of claim 9, wherein the combiner is an interferometer.
